(19) United States
(12) Patent Application Publication
(10) Pub. No.: US 2004/0136464 A1
(43) Pub. Date: Jul. 15, 2004

(54) Apparatus and method for generating a preamble sequence in an OFDM communication system

(75) Inventors: Chang-Ho Suh, Seoul (KR); Chan-Byoung Chae, Seongnam-si (KR); Ho-Kyu Choi, Seongnam-si (KR); Jung-Min Ro, Suwon-si (KR); Pan-Yuh Joo, Seoul (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., GYEONGGI-DO (KR)

(21) Appl. No.: 10/724,666

(22) Filed: Dec. 1, 2003

(30) Foreign Application Priority Data
Nov. 30, 2002 (KR) 75705/2002

(51) Int. Cl. H04K 1/10; H04L 27/28

(52) U.S. Cl. 375/260

(57) ABSTRACT

A method for generating a preamble sequence for decreasing a peak-to-average power ratio (PAPR) through at least two antennas in an orthogonal frequency division multiplexing (OFDM) communication system. The method comprises generating a first preamble sequence in which odd data of the preamble sequence becomes null data and even data of the preamble sequence becomes data, the first preamble sequence being adapted to be transmitted via one of the two antennas; and generating a second preamble sequence in which even data of the preamble sequence becomes null data and odd data of the preamble sequence becomes data, the second preamble sequence being adapted to be transmitted via another one of the two antennas.

### PRIORITY

This application claims priority under 35 U.S.C. § 119 to an application entitled “Apparatus and Method for Generating Preamble Sequence in an OFDM Communication System” filed in the Korean Intellectual Property Office on Nov. 30, 2002 and assigned Serial No. 2002-75705, the contents of which are incorporated herein by reference.

### BACKGROUND OF THE INVENTION

1. Field of the Invention

The present invention relates generally to an orthogonal frequency division multiplexing (OFDM) communication system, and in particular, to an apparatus and method for generating a preamble sequence in an OFDM communication system.

2. Description of the Related Art

In general, a wireless communication system supporting a wireless communication service is comprised of Node Bs and user equipments (UEs). The Node Bs and the UEs transmit data by the frame for a wireless communication service. Therefore, the Node Bs and the UEs must acquire mutual synchronization for transmission and reception of the transmission frame, and for the synchronization acquisition, a Node B must transmit a synchronization signal so that a UE can detect a start of a frame transmitted by the Node B. The UE then detects frame timing of the Node B by receiving the synchronization signal transmitted by the Node B, and demodulates received frames according to the detected frame timing. Commonly, a specific preamble sequence previously appointed by the Node B and the UE is used for the synchronization signal.

Preferably, a preamble sequence having a low peak-to-average power ratio (PAPR) is used for the preamble sequence used in an OFDM communication system. This is because in the OFDM communication system, a high PAPR leads to an increase in power consumption of a radio frequency (RF) amplifier.

A preamble sequence transmitted from a Node B to a UE is created by concatenating a leading preamble sequence S of a long preamble sequence, which is necessary for performing coarse synchronization, to a short preamble sequence P, which is necessary for performing fine frequency synchronization. Only the short preamble is used for the preamble transmitted from the UE to the Node B for acquiring fine frequency synchronization.

The OFDM communication system transmits data for several users, or UEs, by time-multiplexing one frame. In the OFDM communication system, a frame preamble indicating a start of a frame is transmitted for a predetermined period beginning at a start point of the frame. Because data may be irregularly transmitted to the respective users within one frame, a burst preamble indicting the start of data is located at a front part of each data block. Therefore, a UE must receive a data frame in order to identify a transmission start point of the data. The UE should be synchronized to a start point of data in order to receive the data, and to this end, the UE must acquire a preamble sequence that is commonly used by all systems for synchronization before receiving signals.

The OFDM communication system is identical to a non-OFDM communication system in a source coding scheme, a channel coding scheme, and a modulation scheme. While a code division multiple access (CDMA) communication system spreads data before transmission, the OFDM communication system performs inverse fast Fourier transform (IFFT) on data and then inserts a guard interval in the IFFT-transformed data before transmission. Therefore, compared with the CDMA communication system, the OFDM communication system can transmit a wideband signal using relatively simple hardware. In the OFDM communication system, if a parallel bit/symbol stream generated by parallel converting a plurality of serial bit/symbol streams is applied as a frequency-domain IFFT input after modulation is performed on data, an IFFT-transformed time-domain signal is output. The time-domain output signal is obtained by multiplexing a wideband signal with several narrowband subcarrier signals, and a plurality of modulation symbols are transmitted for one OFDM symbol period through the IFFT process.

However, in the OFDM communication system, if the IFFT-transformed OFDM symbol is transmitted as it is, interference between a previous OFDM symbol and a current OFDM symbol is unavoidable. In order to remove the inter-symbol interference, a guard interval is inserted. The guard interval is used to insert null data for a predetermined period. However, in a method of transmitting null data for the guard interval, if a receiver incorrectly estimates a start point of an OFDM symbol, interference occurs between subcarriers, causing an increase in error probability of a received OFDM symbol. Therefore, a “cyclic prefix” scheme or a “cyclic postfix” scheme has been proposed for the guard interval. In the cyclic postfix scheme, last 1/n bits in a time-domain OFDM symbol are copied and then inserted in an effective OFDM symbol, and in the cyclic prefix scheme, first 1/n bits in a time-domain OFDM symbol are copied and then inserted in an effective OFDM symbol.

A receiver may acquire time/frequency synchronization of a received OFDM symbol using a characteristic of the guard interval created by copying a part of one time-domain OFDM symbol, i.e., a beginning part or a last part of one OFDM symbol, and then repeatedly arranging the copied OFDM symbols.

In any radio frequency (RF) system, a transmission signal transmitted by a transmitter is distorted while it passes through a radio channel, and thus, a receiver receives a distorted transmission signal. The receiver acquires time/frequency synchronization of the received distorted transmission signal, using a preamble sequence previously set between the transmitter and the receiver, performs channel estimation, and then demodulates the channel-estimated signal into frequency-domain symbols through fast Fourier transform (FFT). After demodulating the channel-estimated signal into frequency-domain symbols, the receiver performs channel decoding and source decoding corresponding to the channel coding applied in the transmitter on the demodulated symbols, to thereby decode the demodulated symbols into information data.

The OFDM communication system uses a preamble sequence for all frame timing synchronization, frequency synchronization, and channel estimation. The OFDM communication system may perform frame timing synchronization, frequency synchronization, and channel estimation using a guard interval and a pilot subcarrier in addition to the preamble. The preamble sequence is used to transmit previously known symbols at a beginning part of every frame or data burst, and update estimated time/frequency/channel information at a data transmission part, using information on the guard interval and the pilot subcarrier.

FIG. 1 is a diagram illustrating a structure of a long preamble sequence for a conventional OFDM communication system. It should be noted that a current OFDM communication system uses the same preamble sequence in both a downlink (DL) and an uplink (UP). Referring to FIG. 1, in the long preamble sequence, a length-64 sequence is repeated 4 times and a length-128 sequence is repeated 2 times. In light of a characteristic of the OFDM communication system, the above-stated cyclic prefix (CP) is added to a front part of the 4 repeated length-64 sequences and to a front part of the 2 repeated length-128 sequences. In the following description, a sequence consisting of the 4 repeated length-64 sequences is referred to as “S” and a sequence consisting of the 2 repeated length-128 sequences is referred to as “P.”

In addition, as described above, signals obtained before performing IFFT are frequency-domain signals, and signals obtained after performing IFFT are time-domain signals. The long preamble sequence illustrated in FIG. 1 represents a time-domain long preamble sequence obtained after performing IFFT.

Frequency-domain long preamble sequences obtained before performing IFFT are illustrated below by way of example.

$$\begin{matrix}S ( - 100 \text{:} 100 ) = \{ + 1 + j , 0 , 0 , 0 , + 1 + j , 0 , 0 , 0 , + 1 + j , 0 , 0 , 0 , + 1 - j , 0 , 0 , 0 , - 1 + j , 0 , 0 , 0 , + 1 + j , 0 , 0 , 0 , \\ + 1 + j , 0 , 0 , 0 , + 1 + j , 0 , 0 , 0 , + 1 - j , 0 , 0 , 0 , - 1 + j , 0 , 0 , 0 , + 1 + j , 0 , 0 , 0 , + 1 + j , 0 , 0 , 0 , \\ + 1 + j , 0 , 0 , 0 , + 1 - j , 0 , 0 , 0 , - 1 + j , 0 , 0 , 0 , + 1 - j , 0 , 0 , 0 , + 1 - j , 0 , 0 , 0 , + 1 - j , 0 , 0 , 0 , \\ - 1 - j , 0 , 0 , 0 , + 1 + j , 0 , 0 , 0 , - 1 + j , 0 , 0 , 0 , - 1 + j , 0 , 0 , 0 , - 1 + j , 0 , 0 , 0 , + 1 + j , 0 , 0 , 0 , \\ - 1 - j , 0 , 0 , 0 , \\ 0 , 0 , 0 , 0 , \\ - 1 - j , 0 , 0 , 0 , + 1 - j , 0 , 0 , 0 , + 1 + j , 0 , 0 , 0 , - 1 - j , 0 , 0 , 0 , - 1 + j , 0 , 0 , 0 , + 1 - j , 0 , 0 , 0 , \\ + 1 + j , 0 , 0 , 0 , - 1 + j , 0 , 0 , 0 , + 1 - j , 0 , 0 , 0 , - 1 - j , 0 , 0 , 0 , + 1 + j , 0 , 0 , 0 , - 1 + j , 0 , 0 , 0 , \\ - 1 - j , 0 , 0 , 0 , + 1 + j , 0 , 0 , 0 , + 1 - j , 0 , 0 , 0 , - 1 - j , 0 , 0 , 0 , + 1 - j , 0 , 0 , 0 , + 1 + j , 0 , 0 , 0 , \\ - 1 - j , 0 , 0 , 0 , - 1 + j , 0 , 0 , 0 , - 1 + j , 0 , 0 , 0 , - 1 - j , 0 , 0 , 0 , + 1 - j , 0 , 0 , 0 , - 1 + j , 0 , 0 , 0 , \\ + 1 + j \} * sqrt ( 2 ) * sqrt ( 2 )\end{matrix}$$

$$\begin{matrix}P ( - 100 \text{:} 100 ) = \{ - 1 , 0 , + 1 , 0 + 1 , 0 , + 1 , 0 , + 1 , 0 , - 1 , 0 , - 1 , 0 , + 1 , 0 , - 1 , 0 , + 1 , 0 , \\ - 1 , 0 , - 1 , 0 + 1 , 0 , + 1 , 0 , - 1 , 0 , + 1 , 0 , - 1 , 0 , + 1 , 0 , - 1 , 0 , + 1 , 0 , \\ - 1 , 0 , + 1 , 0 + 1 , 0 , - 1 , 0 , + 1 , 0 , - 1 , 0 , - 1 , 0 , + 1 , 0 , - 1 , 0 , - 1 , 0 , \\ - 1 , 0 , + 1 , 0 + 1 , 0 , - 1 , 0 , + 1 , 0 , + 1 , 0 , + 1 , 0 , - 1 , 0 , + 1 , 0 , + 1 , 0 , \\ - 1 , 0 , - 1 , 0 - 1 , 0 , + 1 , 0 , + 1 , 0 , + 1 , 0 , + 1 , 0 , + 1 , 0 , + 1 , 0 , + 1 , 0 , \\ 0 , 0 , \\ - 1 , 0 , - 1 , 0 + 1 , 0 , - 1 , 0 , - 1 , 0 , + 1 , 0 , + 1 , 0 , + 1 , 0 , - 1 , 0 , + 1 , 0 , \\ + 1 , 0 , + 1 , 0 - 1 , 0 , - 1 , 0 , - 1 , 0 , - 1 , 0 , - 1 , 0 , - 1 , 0 , + 1 , 0 , - 1 , 0 , \\ - 1 , 0 , - 1 , 0 - 1 , 0 , - 1 , 0 , - 1 , 0 , + 1 , 0 , + 1 , 0 , + 1 , 0 , - 1 , 0 , + 1 , 0 , \\ - 1 , 0 , + 1 , 0 + 1 , 0 , - 1 , 0 , + 1 , 0 , + 1 , 0 , + 1 , 0 , - 1 , 0 , - 1 , 0 , - 1 , 0 , \\ - 1 , 0 , - 1 , 0 + 1 , 0 , - 1 , 0 , - 1 , 0 , + 1 , 0 , - 1 , 0 , - 1 , 0 , + 1 , 0 , - 1 \} * \\ sqrt ( 2 ) * sqrt ( 2 )\end{matrix}$$

Numerals specified in the frequency-domain long preamble sequences S(−100:100) and P(−100:100) represent subcarriers' positions applied while IFFT is performed, and a detailed description thereof will be made herein below with reference to FIG. 3. S(−100:100) represents a frequency-domain preamble sequence obtained by repeating a length-64 sequence 4 times, and P(−100:100) represents a frequency-domain preamble sequence obtained by repeating a length-128 sequence 2 times.

FIG. 2 is a diagram illustrating a structure of a short preamble sequence for a conventional OFDM communication system. Referring to FIG. 2, in the short preamble sequence, a length-128 sequence is repeated 2 times. In light of a characteristic of the OFDM communication system, the above-stated cyclic prefix (CP) is added to a front part of the 2 repeated length-128 sequences. In addition, the short preamble sequence illustrated in FIG. 2 represents a time-domain short preamble sequence obtained after performing IFFT, and a frequency-domain short preamble sequence equals the P(−100:100). As illustrated in FIGS. 1 and 2, a following portion (part) of the long preamble sequence has the same structure as the short preamble sequence. Hereinafter, the following part of the long preamble sequence and the short preamble sequence can be used in the same meaning.

The long preamble sequence stated above must be generated taking the following conditions into consideration.

(1) The long preamble sequence should have a low PAPR.

In order to maximize transmission efficiency of a power amplifier (PA) in a transmitter of an OFDM communication system, a PAPR of an OFDM symbol must be low. That is, because an IFFT-transformed signal is applied to a power amplifier having a non-linear characteristic, a low PAPR is required. A PAPR of an OFDM symbol must be low in a ratio of maximum power to average power of a time-domain OFDM symbol corresponding to an IFFT processor's output terminal of the transmitter, and for a low ratio of the maximum power to the average power, uniform distribution must be provided. In other words, a PAPR of an output becomes low if symbols having a low cross correlation are combined in an IFFT processor's input terminal of the transmitter, i.e., in a frequency domain.

(2) The long preamble sequence should be suitable for parameter estimation needed for communication initialization.

The parameter estimation includes channel estimation, frequency offset estimation, and time offset estimation.

(3) The long preamble sequence should have low complexity and low overhead.

(4) The long preamble sequence should be available for coarse frequency offset estimation.

A function of the long preamble sequences generated considering the foregoing conditions will now be described herein below.

(1) A sequence obtained by repeating a length-64 sequence 4 times is used for time offset estimation and coarse frequency offset estimation.

(2) A sequence obtained by repeating a length-128 sequence 2 times is used for fine frequency offset estimation.

As a result, the long preamble sequence has the following uses in the OFDM communication system.

(1) The long preamble sequence is used as a first preamble sequence of a downlink protocol data unit (PDU).

(2) The long preamble sequence is used for initial ranging.

(3) The long preamble sequence is used for bandwidth request ranging.

Further, the short preamble sequence has the following uses in the OFDM communication system.

(1) The short preamble sequence is used as an uplink data preamble sequence.

(2) The short preamble sequence is used for periodic ranging.

In the OFDM communication system, because accurate synchronization can be acquired by performing initial ranging and periodic ranging, the uplink data preamble sequence is mainly used for channel estimation. For channel estimation, PAPR, performance and complexity should be taken into consideration. In the case of the existing short preamble sequence, a PAPR shows 3.5805 [dB], and various channel estimation algorithms such as a minimum mean square error (MMSE) algorithm and a least square (LS) algorithm are used.

FIG. 3 is a diagram illustrating a mapping relation between subcarriers and a preamble sequence during IFFT in an OFDM communication system. It is assumed in FIG. 3 that if the number of all of the subcarriers for an OFDM communication system is 256, the 256 subcarriers include −128^{th} to 127^{th} subcarriers, and if the number of subcarriers actually in use is 200, the 200 subcarriers include −100^{th}, . . . , −1^{st}, 1^{st}, . . . , 100^{th} subcarriers. In FIG. 3, numerals at an IFFT processor's input terminal represent frequency components, i.e., unique numbers of subcarriers. The reason for inserting null data, or 0-data, in a 0^{th} subcarrier is because the 0^{th} subcarrier, after performing IFFT, represents a reference point of a preamble sequence in a time domain, i.e., represents a DC (Direct Current) component in a time domain.

The null data is inserted into 28 subcarriers of the −128^{th} to −101^{st} subcarriers and 27 subcarriers of the 101^{th} to 127^{th} subcarriers, excluding the 200 subcarriers actually in use and the 0^{th} subcarrier. Here, the reason for inserting null data into 28 subcarriers of the −128^{th} to −101^{st} subcarriers and 27 subcarriers of the 101^{st} to 127^{th} subcarriers is to provide a guard interval in a frequency domain because the 28 subcarriers of the −128^{th} to −101^{st} subcarriers and the 27 subcarriers of the 101^{st} to 127^{th} subcarriers correspond to a high frequency band in the frequency domain. As a result, if a frequency-domain preamble sequence of S(−100:100) or P(−100:100) is applied to an IFFT processor, the IFFT processor maps the frequency-domain preamble sequence of S(−100:100) or P(−100:100) to corresponding subcarriers, IFFT-transforms the mapped preamble sequence, and outputs a time-domain preamble sequence.

FIG. 4 is a block diagram illustrating a transmitter structure of a conventional OFDM communication system, which transmits data using one transmission antenna. If information bits to be transmitted are generated in the OFDM communication system, the information bits are applied to a symbol mapper 411. The symbol mapper 411 symbol-maps the input information bits by a preset modulation scheme, and then provides the symbol-mapped information bits to a serial-to-parallel (S/P) converter 413. The S/P converter 413 performs 256-point parallel conversion on the symbol received from the symbol mapper 411 and provides its output to a selector 417. As described above, “256” in the 256-point parallel conversion indicates the number of subcarriers. A preamble sequence generator 415, under the control of a controller (not shown), generates a corresponding preamble sequence and provides the generated preamble sequence to the selector 417. The corresponding preamble sequence represents S(−100:100) or P(−100:100) described in conjunction with FIGS. 1 and 2. The selector 417 selects a signal output from the S/P converter 413 or a signal output from the preamble sequence generator 415 according to scheduling of a corresponding time, and provides the selected signal to an IFFT processor 419.

The selector 417 determines whether it will transmit the preamble sequence generated by the preamble sequence generator 415 or the symbols generated by the S/P converter 413. If the selector 417 determines to transmit a preamble sequence, it transmits the preamble sequence generated by the preamble sequence generator 415. However, if the selector 417 determines to transmit symbols, it transmits the symbols generated by the S/P converter 413.

The IFFT processor 419 performs 256-point IFFT on a signal received from the S/P converter 413 or the preamble sequence generator 415, and provides its output to a parallel-to-serial (P/S) converter 421. In addition to the signal output from the IFFT processor 419, a cyclic prefix is applied to the P/S converter 421. The P/S converter 421 serial-converts the signal output from the IFFT processor 419 and the cyclic prefix, and provides its output to a digital-to-analog (D/A) converter 423. The D/A converter 423 analog-converts a signal output from the P/S converter 421, and provides the analog-converted signal to a radio frequency (RF) processor 425. The RF processor 425 including a filter, RF-processes a signal output from the D/A converter 423 so that it can be transmitted over the air, and then transmits the RF signal via an antenna.

In a receiver, channel estimation is performed by a preamble sequence generated from the short preamble sequence. However, the short preamble sequence P(−100:100) is a short preamble sequence of an even subcarrier. The “short preamble sequence of an even subcarrier” means a preamble sequence for which a unique number of a subcarrier into which data of +1 or −1, not null data, is inserted among elements constituting the short preamble sequence is an even number. Although the 0^{th} subcarrier (DC component) is an even subcarrier, it is excluded herein because null data should be necessarily inserted therein.

One of the main functions of the short preamble sequence P(−100:100) is channel estimation as described above. However, when channel estimation is performed using only a short preamble sequence of the even subcarrier, a channel corresponding to an odd subcarrier cannot be estimated, so channel estimation must be performed on an even subcarrier. Such estimation causes performance deterioration. For performance improvement by the channel estimation, a short preamble sequence of an even subcarrier and a short preamble sequence of an odd subcarrier are both required. However, the existing short preamble sequence P(−100:100) is a short preamble sequence of an even subcarrier, and a short preamble sequence of an odd subcarrier does not exist.

Accordingly, there is a demand for an odd subcarrier's short preamble sequence having a low PAPR.

### SUMMARY OF THE INVENTION

It is, therefore, an object of the present invention to provide an apparatus and method for generating a short preamble sequence of an odd subcarrier so that correct channel estimation is performed at a receiver antenna.

It is another object of the present invention to provide an apparatus and method for generating an odd subcarrier's short preamble sequence having a low PAPR.

It is further another object of the present invention to provide an apparatus and method for transmitting a short preamble sequence of an odd subcarrier and a short preamble sequence of an even subcarrier using one antenna.

It is still another object of the present invention to provide an apparatus and method for transmitting a short preamble sequence of an odd subcarrier and a short preamble sequence of an even subcarrier using a plurality of antennas.

To achieve the above and other objects, there is provided an apparatus and method for generating a preamble sequence in an orthogonal frequency division multiplexing (OFDM) communication system having at least one transmission antenna. The apparatus and method proposes an odd subcarrier's short preamble sequence having a low peak-to-average power ratio (PAPR), so that a receiver can perform accurate channel estimation using the odd subcarrier's short preamble sequence. That is, a preamble sequence is generated using the proposed odd subcarrier's short preamble sequence and an even subcarrier's short preamble sequence, and then transmitted to the receiver. Then the receiver performs accurate channel estimation using the odd subcarrier's short preamble sequence and the even subcarrier's short preamble sequence.

### BRIEF DESCRIPTION OF THE DRAWINGS

The above and other objects, features, and advantages of the present invention will become more apparent from the following detailed description when taken in conjunction with the accompanying drawings in which:

FIG. 1 is a diagram illustrating a structure of a long preamble sequence for a conventional OFDM communication system;

FIG. 2 is a diagram illustrating a structure of a short preamble sequence for a conventional OFDM communication system;

FIG. 3 is a diagram illustrating a mapping relation between subcarriers and a preamble sequence during IFFT in a conventional OFDM communication system;

FIG. 4 is a block diagram illustrating a transmitter structure of a conventional OFDM communication system using one transmission antenna;

FIG. 5 is a block diagram illustrating a transmitter structure of an OFDM communication system using two transmission antennas according to an embodiment of the present invention;

FIG. 6 illustrates Preamble Transmission Rule 1 for transmitting a preamble in an OFDM communication system using one transmission antenna and a corresponding preamble sequence generation procedure according to an embodiment of the present invention;

FIG. 7 illustrates Preamble Transmission Rule 2 for transmitting a preamble in an OFDM communication system using two transmission antennas and a corresponding preamble sequence generation procedure according to an embodiment of the present invention;

FIG. 8 illustrates Preamble Transmission Rule 3 for transmitting a preamble in an OFDM communication system using two transmission antennas and a corresponding preamble sequence generation procedure according to an embodiment of the present invention;

FIG. 9 is a diagram illustrating a mapping relation between subcarriers and a preamble sequence during IFFT in an OFDM communication system using one transmission antenna according to an embodiment of the present invention; and

FIG. 10 is a diagram illustrating a mapping relation between subcarriers and a preamble sequence during IFFT in an OFDM communication system using two transmission antennas according to another embodiment of the present invention.

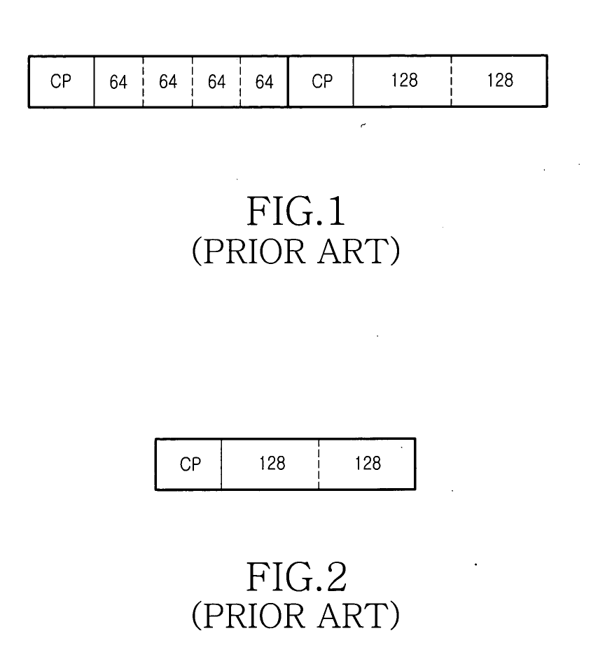

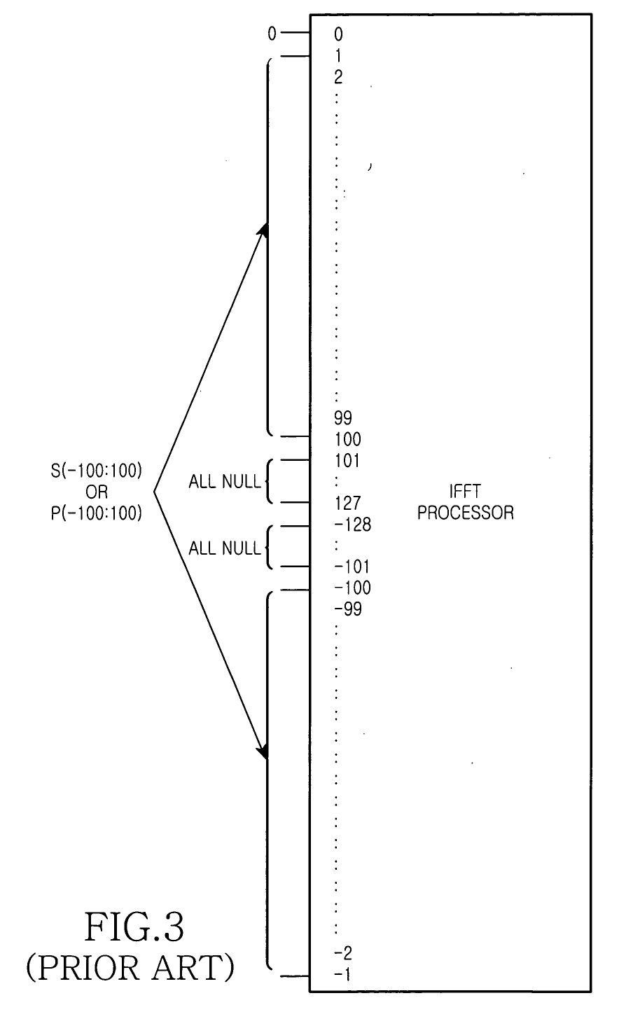

### DETAILED DESCRIPTION OF THE PREFERRED EMBODIMENT

Several preferred embodiments of the present invention will now be described in detail herein below with reference to the annexed drawings. In the following description, a detailed description of known functions and configurations incorporated herein has been omitted for conciseness.

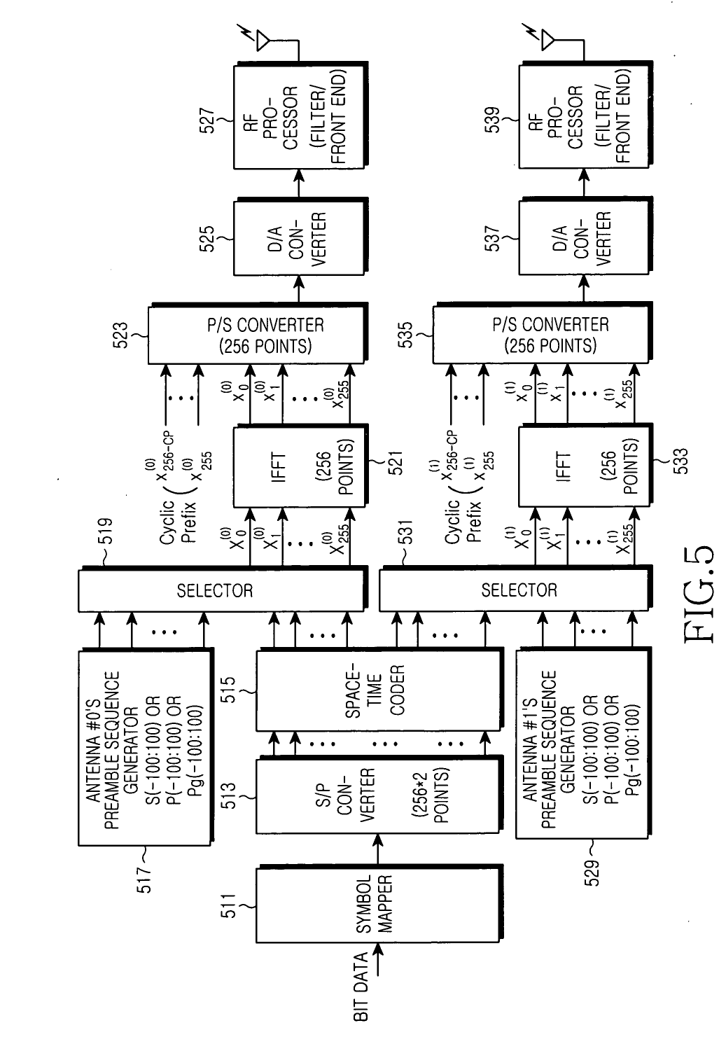

FIG. 5 is a block diagram illustrating a transmitter structure of an OFDM communication system using two transmission antennas. Referring to FIG. 5, if information bits to be transmitted are generated in the OFDM communication system, the information bits are applied to a symbol mapper 511. The symbol mapper 511 symbol-maps the input information bits, and then provides the symbol-mapped information bits to a serial-to-parallel (S/P) converter 513. The S/P converter 513 performs 256*2-point parallel conversion on the symbol output from the symbol mapper 511. In the 256*2-point parallel conversion, “256” indicates the number of subcarriers and “2” indicates the number of antennas. That is, if the symbol mapper 511 generates 256 symbols for an antenna #0 and 256 symbols for an antenna #1, the S/P converter 513 converts received 512 symbols from the symbol mapper 511 into parallel symbols. Generally, symbols output from the S/P converter 513 are called “OFDM symbols.” The OFDM symbols output from the S/P converter 513 are delivered to a space-time coder 515.

The space-time coder 515 performs the following procedure. Of 512 parallel symbols generated from the S/P converter 513, high 256 OFDM symbols are represented by S₀ and low 256 OFDM symbols are represented by S₁. As illustrated in Table 1 below, the OFDM symbols S0 and S1 can be combined with OFDM symbols—S₁* and S₀*, and transmitted for two OFDM-symbol periods.

TABLE 1

| | Antenna #0 | Antenna #1 |
|---|---|---|
| | selector | selector |
| time 0 | S₀ | S₁ |
| time 1 | −S₁* | S₀* |

The space-time coder 515 can apply various space-time coding methods other than the above symbol mapping method.

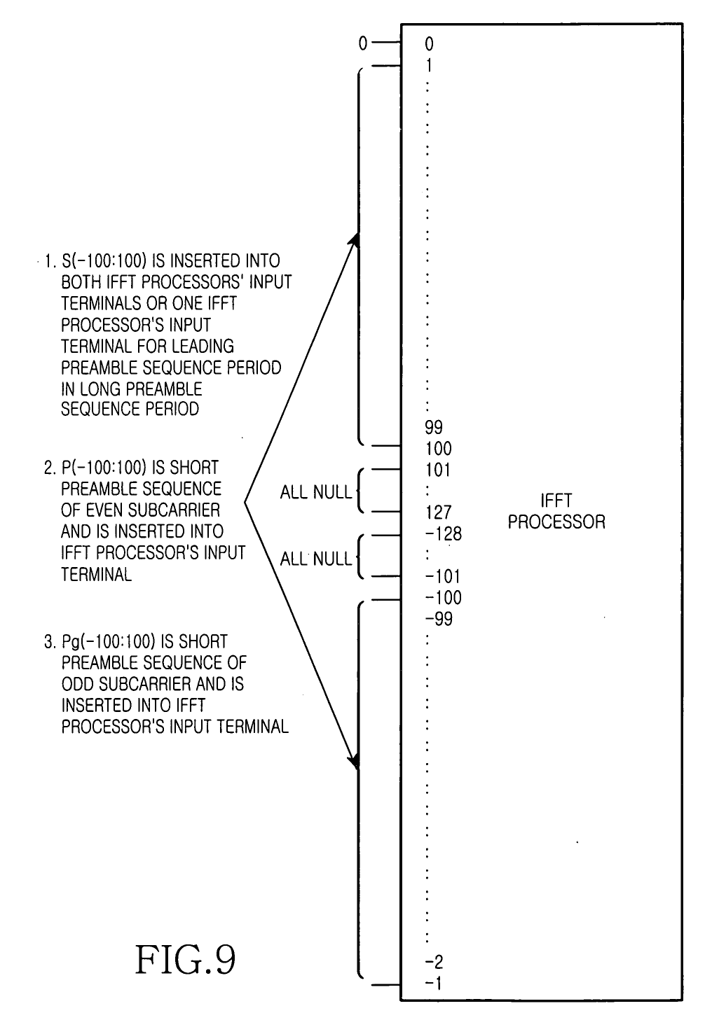

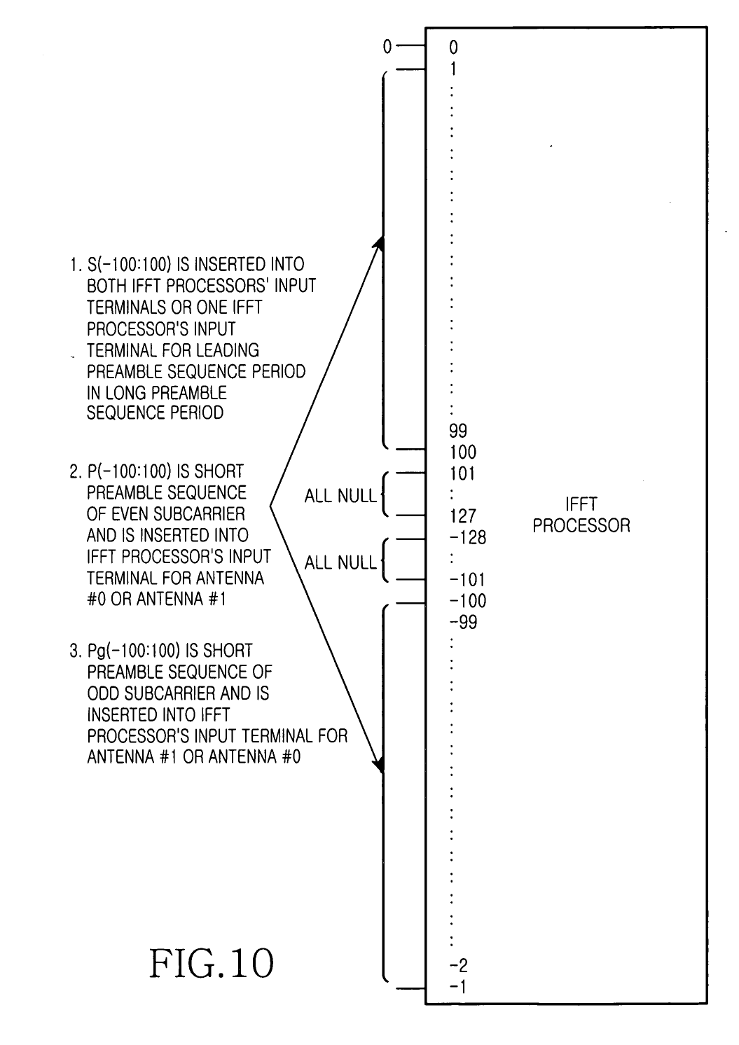

An antenna #0's preamble sequence generator 517 generates a preamble sequence under the control of a controller (not shown), and provides the generated preamble sequence to a selector 519. As illustrated, in an embodiment of the present invention, the antenna #0's preamble sequence generator 517 generates 3 preamble sequences. The 3 preamble sequences include S(−100:100), P(−100:100), and Pg(−100:100). The Pg(−100:100) will be described in detail herein below with reference to FIGS. 9 and 10.

That is, the antenna #0's preamble sequence generator 517 generates one of the 3 preamble sequences according to a control command from the controller. The selector 519 selects a signal output from the space-time coder 515 or a signal output from the antenna #0's preamble sequence generator 517 according to scheduling of a corresponding time, and provides its output to an IFFT processor 521. In other words, the selector 519 determines whether it will transmit the preamble sequence generated by the antenna #0's preamble sequence generator 517 or the symbols generated by the space-time coder 515. If the selector 519 determines to transmit a preamble sequence, it transmits the preamble sequence generated by the antenna #0's preamble sequence generator 517. In contrast, if the selector 519 determines to transmit symbols, it transmits the symbols generated by the space-time coder 515.

The IFFT processor 521 performs 256-point IFFT on a signal output from the space-time coder 515 or the antenna #0's preamble sequence generator 517, and provides its output to a parallel-to-serial (P/S) converter 523. As described above, “256” in the 256-point IFFT represents 256 subcarriers. In addition to the signal output from the IFFT 521, a cyclic prefix is applied to the P/S converter 523. The P/S converter 523 serial-converts the signal output from the IFFT 521 and the cyclic prefix, and provides its output to a digital-to-analog (D/A) converter 525. The D/A converter 525 analog-converts a signal output from the P/S converter 523, and provides its output to an RF processor 527. The RF processor 527 including a filter, RF-processes a signal output from the D/A converter 525 so that it can be transmitted over the air, and then transmits the RF signal via an antenna #0.

An antenna #1's preamble sequence generator 529 generates a preamble sequence under the control of the controller, and provides the generated preamble sequence to a selector 531. As illustrated, in the embodiment of the present invention, the antenna #1's preamble sequence generator 529 generates 3 preamble sequences. Again, the 3 preamble sequences include S(−100:100), P(−100:100), and Pg(−100:100).

That is, the antenna #1's preamble sequence generator 529 generates one of the 3 preamble sequences according to a control command from the controller. The selector 531 selects a signal output from the space-time coder 515 or a signal output from the antenna #1's preamble sequence generator 529 according to scheduling of a corresponding time, and provides its output to an IFFT processor 533. In other words, the selector 531 determines whether it will transmit the preamble sequence generated by the antenna #1's preamble sequence generator 529 or the symbols generated by the space-time coder 515. If the selector 531 determines to transmit a preamble sequence, it transmits the preamble sequence generated by the antenna #1's preamble sequence generator 529. In contrast, if the selector 531 determines to transmit symbols, it transmits the symbols generated by the space-time coder 515.

The IFFT processor 533 performs 256-point IFFT on a signal output from the space-time coder 515 or the antenna #1's preamble sequence generator 529, and provides its output to a P/S converter 535. In addition to the signal output from the IFFT 533, a cyclic prefix is applied to the P/S converter 535. The P/S converter 535 serial-converts the signal output from the IFFT 533 and the cyclic prefix, and provides its output to a D/A converter 537. The D/A converter 537 analog-converts a signal output from the P/S converter 535, and provides its output to an RF processor 539. The RF processor 539 including a filter, RF-processes a signal output from the D/A converter 537 so that it can be transmitted over the air, and then transmits the RF signal via an antenna #1.

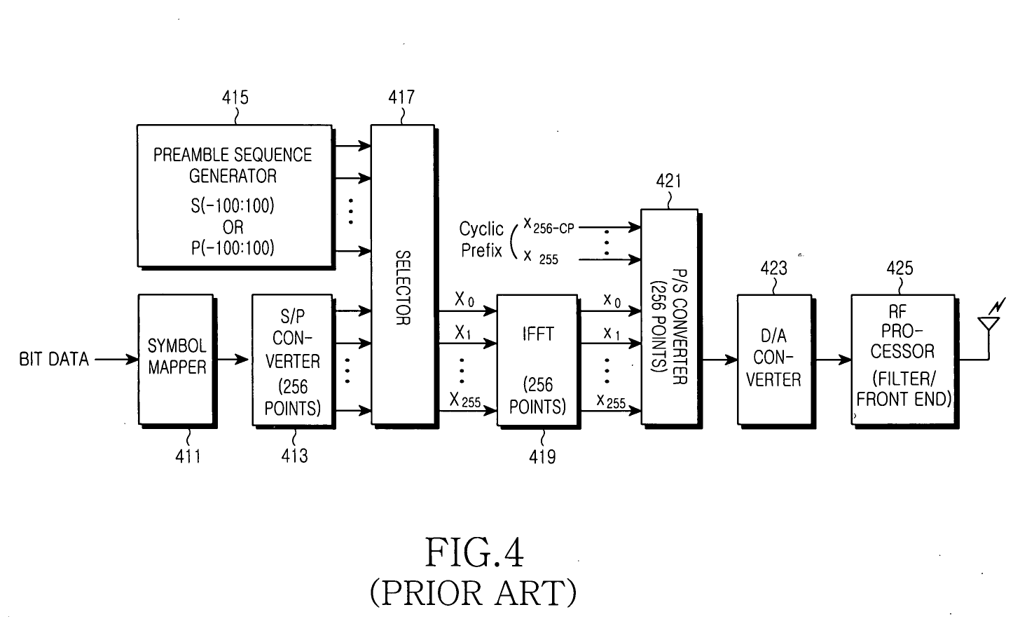

A procedure for transmitting data or a preamble sequence using 2 transmission antennas has been described so far with reference to FIG. 5. However, it is also possible to transmit the data or preamble sequence using one transmission antenna. With reference to FIG. 4, a description will now be made of a procedure for transmitting data or a preamble sequence using one transmission antenna.

If information bits to be transmitted are generated in the OFDM communication system, the information bits are applied to a symbol mapper 411. The symbol mapper 411 symbol-maps the input information bits by a preset modulation scheme, and then provides the symbol-mapped information bits to an S/P converter 413. The S/P converter 413 performs 256-point parallel conversion on the symbol received from the symbol mapper 411 and provides its output to a selector 417. A preamble sequence generator 415, under the control of a controller (not shown), generates a corresponding preamble sequence and provides the generated preamble sequence to the selector 417.

The preamble sequence generator 415 generates 3 preamble sequences, and the 3 preamble sequences include S(−100:100), P(−100:100), and Pg(−100:100). The selector 417 selects a signal output from the S/P converter 413 or a signal output from the preamble sequence generator 415 according to scheduling of a corresponding time, and provides the selected signal to an IFFT processor 419. In other words, the selector 417 determines whether it will transmit the preamble sequence generated by the preamble sequence generator 415 or the symbols generated by the S/P converter 413. If the selector 417 determines to transmit a preamble sequence, it transmits the preamble sequence generated by the preamble sequence generator 415. In contrast, if the selector 417 determines to transmit symbols, it transmits the symbols generated by the S/P converter 413.

The IFFT processor 419 performs 256-point IFFT on a signal received from the S/P converter 413 or the preamble sequence generator 415, and provides its output to a P/S converter 421. In addition to the signal output from the IFFT processor 419, a cyclic prefix is applied to the P/S converter 421. The P/S converter 421 serial-converts the signal output from the IFFT processor 419 and the cyclic prefix, and provides its output to a D/A converter 423. The D/A converter 423 analog-converts a signal output from the P/S converter 421, and provides the analog-converted signal to an RF processor 425. The RF processor 425 including a filter, RF-processes a signal output from the D/A converter 423 so that it can be transmitted over the air, and then transmits the RF signal via an antenna.

As described above, although the conventional preamble sequence generator generates only 2 preamble sequences of S(−100:100) and P(−100:100), the new preamble sequence generator can generate 3 preamble sequences of S(−100:100), P(−100:100), and Pg(−100:100). The Pg(−100:100) is a short preamble sequence of an odd subcarrier in a frequency domain. In the OFDM communication system, signals obtained before performing IFFT are frequency-domain signals, and signals obtained after performing IFFT are time-domain signals. The “short preamble sequence of an odd subcarrier” refers to a preamble sequence for which a unique number of a subcarrier into which data of +1 or −1, not null data, is inserted among elements constituting the short preamble sequence is an odd number.

With reference to FIGS. 9 and 10, a description will now be made of a preamble sequence generated by the preamble sequence generator and a mapping relation between subcarriers and a preamble sequence during IFFT in an OFDM communication system. The present invention proposes an apparatus and method for generating an odd subcarrier's short preamble sequence having a minimum PAPR in an OFDM communication system in which the total number of subcarriers is 256 and unique numbers of subcarriers actually in use are −100, −99, . . . −1, 1 . . . , 99, 100. The preamble sequence is classified into a long preamble sequence and a short preamble sequence. In the long preamble sequence, a length-64 sequence is repeated 4 times and a length-128 sequence is repeated 2 times, and in the light of a characteristic of the OFDM communication system, a cyclic prefix is added to a front part of the 4 repeated length-64 sequences and a front part of the 2 repeated length-128 sequences. Further, in the short preamble sequence, a length-128 sequence is repeated 2 times, and in the light of a characteristic of the OFDM communication system, the cyclic prefix is added to a front part of the 2 repeated length-128 sequences.

Of the preamble sequences S(−100:100), P(−100:100), and Pg(−100:100) generated by the preamble sequence generator, S(100:100) and P(−100:100) are identical to the preamble sequences described in the related art section, and Pg(−100:100) proposed in the present invention is given by

$$\begin{matrix}Pg ( - 100 \text{:} 100 ) = \{ 0 , - 1 , 0 , - 1 , 0 , + 1 , 0 , - 1 , 0 , + 1 , 0 , - 1 , 0 , + 1 , 0 , + 1 , 0 , - 1 , 0 , - 1 , \\ 0 , + 1 , 0 , + 1 , 0 , - 1 , 0 , + 1 , 0 , - 1 , 0 , + 1 , 0 , - 1 , 0 , - 1 , 0 , + 1 , 0 , + 1 , \\ 0 , + 1 , 0 , + 1 , 0 , - 1 , 0 , + 1 , 0 , - 1 , 0 , + 1 , 0 , - 1 , 0 , - 1 , 0 , + 1 , 0 , + 1 , \\ 0 , - 1 , 0 , - 1 , 0 , + 1 , 0 , - 1 , 0 , + 1 , 0 , - 1 , 0 , + 1 , 0 , + 1 , 0 , - 1 , 0 , - 1 , \\ 0 , - 1 , 0 , - 1 , 0 , + 1 , 0 , + 1 , 0 , + 1 , 0 , + 1 , 0 , + 1 , 0 , - 1 , 0 , + 1 , 0 , + 1 , \\ , - 1 , \\ 0 , - 1 , 0 , + 1 , 0 , - 1 , 0 , + 1 , 0 , - 1 , 0 , + 1 , 0 , + 1 , 0 , - 1 , 0 , - 1 , 0 , - 1 , \\ 0 , - 1 , 0 , + 1 , 0 , + 1 , 0 , + 1 , 0 , + 1 , 0 , + 1 , 0 , - 1 , 0 , + 1 , 0 , + 1 , 0 , - 1 , \\ 0 , - 1 , 0 , + 1 , 0 , + 1 , 0 , + 1 , 0 , + 1 , 0 , + 1 , 0 , - 1 , 0 , + 1 , 0 , + 1 , 0 , - 1 , \\ 0 , - 1 , 0 , + 1 , 0 , + 1 , 0 , + 1 , 0 , + 1 , 0 , + 1 , 0 , - 1 , 0 , + 1 , 0 , + 1 , 0 , + 1 , \\ 0 , + 1 , 0 , - 1 , 0 , - 1 , 0 , - 1 , 0 , - 1 , 0 , - 1 , 0 , + 1 , 0 , - 1 , 0 , - 1 , 0 \} * \\ sqrt ( 2 ) * sqrt ( 2 )\end{matrix}$$

As indicated above, FIG. 9 is a diagram illustrating a mapping relation between subcarriers and a preamble sequence during IFFT in an OFDM communication system using one transmission antenna according to an embodiment of the present invention. It is assumed in FIG. 9 that if the number of all of the subcarriers for an OFDM communication system is 256, the 256 subcarriers include −128^{th} to 127^{th} subcarriers, and if the number of subcarriers actually in use is 200, the 200 subcarriers include −100^{th}, . . . , −1^{st}, 1^{st}, . . . , 100^{th} subcarriers. In FIG. 9, numerals at an IFFT processor's input terminal represent frequency components, i.e., unique numbers of subcarriers. The reason for inserting null data, or 0-data, in a 0^{th} subcarrier is because the 0^{th} subcarrier, after performing IFFT, represents a reference point of a preamble sequence in a time domain, i.e., represents a DC component in a time domain. The null data is inserted into 28 subcarriers of the −128^{th} to −101^{st} subcarriers and 27 subcarriers of the 101^{st} to 127^{th} subcarriers, excluding the 200 subcarriers actually in use and the 0^{th} subcarrier. Again, the reason for inserting null data into 28 subcarriers of the −128^{th} to −101^{st} subcarriers and 27 subcarriers of the 101^{st} to 127^{th} subcarriers is to provide a guard interval in a frequency domain because the 28 subcarriers of the −128^{th} to −101^{st} subcarriers and the 27 subcarriers of the 101^{st} to 127^{th} subcarriers correspond to a high frequency band in the frequency domain. As a result, if a frequency-domain preamble sequence of S(−100:100), P(−100:100), or Pg(−100:100) is applied to the IFFT processor, the IFFT processor maps the frequency-domain preamble sequence of S(−100:100), P(−100:100), or Pg(−100:100) to corresponding subcarriers, IFFT-transforms the mapped preamble sequence, and outputs a time-domain preamble sequence.

A description will now be made herein below of situations in which the S(−100:100), P(−100:100), and Pg(−100:100) are used.

(1) S(−100:100)

S(−100:100) is inserted into IFFT processors' input terminals of both antennas (antenna #0 and antenna #1) or an IFFT processor's input terminal of one antenna for a leading preamble sequence period in a long preamble sequence period.

(2) P(−100:100)

P(−100:100) is a short preamble sequence of an even subcarrier and is inserted into an IFFT processor's input terminal. The “short preamble sequence of an even subcarrier” means a preamble sequence for which a unique number of a subcarrier into which data of +1 or −1, not null data, is inserted among elements constituting the short preamble sequence is an even number.

(3) Pg(−100:100)

Pg(−100:100) is a short preamble sequence of an odd subcarrier and is inserted into an IFFT processor's input terminal. The “short preamble sequence of an odd subcarrier” means a preamble sequence for which a unique number of a subcarrier into which data of +1 or −1, not null data, is inserted among elements constituting the short preamble sequence is an odd number. That is, this is an odd subcarrier's short preamble sequence proposed in the present invention.

FIG. 10 is a diagram illustrating a mapping relation between subcarriers and a preamble sequence during IFFT in an OFDM communication system using two transmission antennas according to another embodiment of the present invention. It is assumed in FIG. 10 that if the number of all of the subcarriers for an OFDM communication system is 256, the 256 subcarriers include −128^{th} to 127^{th} subcarriers, and if the number of subcarriers actually in use is 200, the 200 subcarriers include −100^{th}, . . . , −1^{st}, 1^{st}, . . . , 100^{th} subcarriers. In FIG. 10, numerals at an IFFT processor's input terminal represent frequency components, i.e., unique numbers of subcarriers. Again, the reason for inserting null data, or 0-data, in a 0^{th} subcarrier is because the 0^{th} subcarrier, after performing IFFT, represents a reference point of a preamble sequence in a time domain, i.e., represents a DC component in a time domain.

The null data is inserted into 28 subcarriers of the −128^{th} to −101^{st} subcarriers and 27 subcarriers of the 101^{st} to 127^{th} subcarriers, excluding the 200 subcarriers actually in use and the 0^{th} subcarrier. The reason for inserting null data into 28 subcarriers of the −128^{th} to 101^{st} subcarriers and 27 subcarriers of the 101^{st} to 127^{th} subcarriers is to provide a guard interval in a frequency domain because the 28 subcarriers of the −128^{th} to −101^{st} subcarriers and the 27 subcarriers of the 101^{st} to 127^{th} subcarriers correspond to a high frequency band in the frequency domain. If a frequency-domain preamble sequence of S(−100:100), P(−100:100), or Pg(−100:100) is applied to the IFFT processor, the IFFT processor maps the frequency-domain preamble sequence of S(−100:100), P(−100:100), or Pg(−100:100) to corresponding subcarriers, IFFT-transforms the mapped preamble sequence, and outputs a time-domain preamble sequence. A description will now be made of situations in which the S(−100:100), P(−100:100), and Pg(−100:100) are used.

(1) S(−100:100)

S(−100:100) is inserted into IFFT processors' input terminals of both antennas (antenna #0 and antenna #I) or an IFFT processor's input terminal of one antenna for a leading preamble sequence period in a long preamble sequence period.

(2) P(−100:100)

P(−100:100) is a short preamble sequence of an even subcarrier and is inserted into an IFFT processor's input terminal for an antenna #0 or an antenna #1. The “short preamble sequence of an even subcarrier” means a preamble sequence for which a unique number of a subcarrier into which data of +1 or −1, not null data, is inserted among elements constituting the short preamble sequence is an even number.

(3) Pg(−100:100)

Pg(−100:100) is a short preamble sequence of an odd subcarrier and is inserted into an IFFT processor's input terminal for an antenna #1 or an antenna #0. The “short preamble sequence of an odd subcarrier” means a preamble sequence for which a unique number of a subcarrier into which data of +1 or −1, not null data, is inserted among elements constituting the short preamble sequence is an odd number. That is, this is an odd subcarrier's short preamble sequence proposed in the present invention.

Consequently, unlike the conventional technology, the present invention proposes an apparatus for generating an odd subcarrier's short preamble sequence having a low PAPR in an OFDM communication system using one or more transmission antennas, thereby improving performance of the OFDM communication system.

In the OFDM communication system using 2 transmission antennas, the odd subcarrier's short preamble sequence proposed in the present invention has a PAPR of 2.7448 dB.

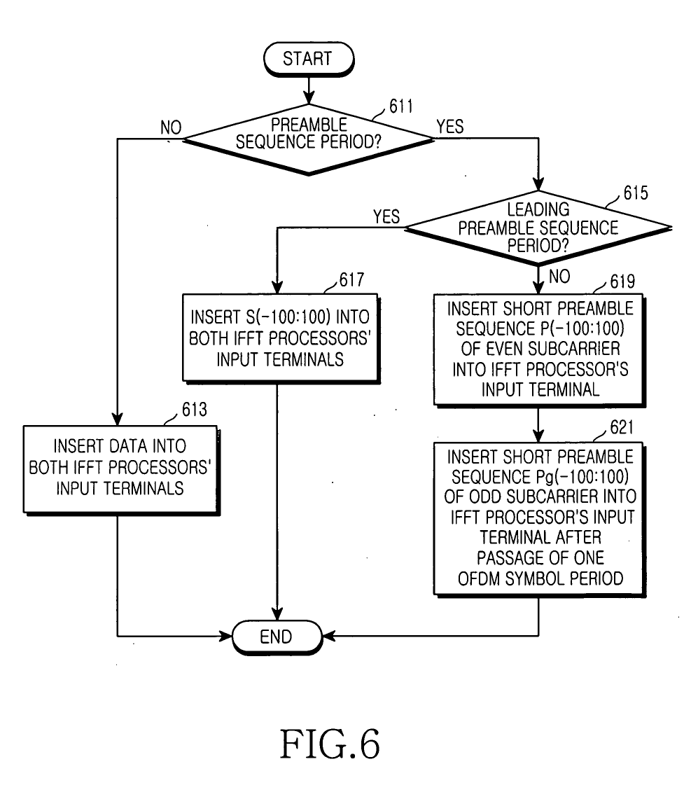

FIG. 6 illustrates Preamble Transmission Rule 1 for transmitting a preamble in an OFDM communication system using one transmission antenna according to an embodiment of the present invention. With reference to FIG. 6, a detailed description will now be made of Preamble Transmission Rule 1 according to an embodiment of the present invention.

In step 611, a transmitter determines whether a transmission signal period is a preamble sequence period. The transmission signal is determined and selected by a selector as described above. If the transmission signal period is not a preamble sequence period, but a data transmission period, the transmitter proceeds to step 613. In step 613, the transmitter performs a control operation of mapping data to both IFFT processors' input terminals, and then ends the procedure. However, if it is determined in step 611 that the transmission signal period is a preamble sequence period, the transmitter proceeds to step 615. In step 615, the transmitter determines whether the preamble sequence period is a leading preamble sequence period in a long preamble sequence period. If the preamble sequence period is a leading preamble sequence period in a long preamble sequence period, the transmitter proceeds to step 617, where the transmitter performs a control operation of mapping a leading preamble sequence S(−100:100) in the long preamble sequence period to corresponding subcarriers on the IFFT processor's input terminal, and then ends the procedure. The preamble sequence S(−100:100) is generated by a preamble sequence generator according to a control command from a controller, as described above.

However, If it is determined in step 615 that the preamble sequence period is not a leading preamble sequence period in a long preamble sequence period, but a short preamble sequence period (a following part period of the long preamble sequence period), then the transmitter proceeds to step 619.

In step 619, the transmitter maps an even subcarrier's short preamble sequence P(−100:100) to the IFFT processor's input terminal. The even subcarrier's short preamble sequence is identical to that described above. In step 621, the transmitter maps an odd subcarrier's short preamble sequence Pg(−100:100) to the IFFT processor's input terminal after passage of one OFDM symbol period, and then ends the procedure. The odd subcarrier's short preamble sequence is also identical to that described above.

In summary, in Preamble Transmission Rule 1, the transmitter transmits both the odd subcarrier's short preamble sequence and the even subcarrier's short preamble sequence, so that a receiver can easily perform channel estimation. That is, conventionally, an odd subcarrier's short preamble sequence was estimated using only an even subcarrier's short preamble sequence. However, using the conventional method a receiver could not perform accurate channel estimation. Therefore, using Preamble Transmission Rule 1 according to the present invention, a receiver can easily perform channel estimation.

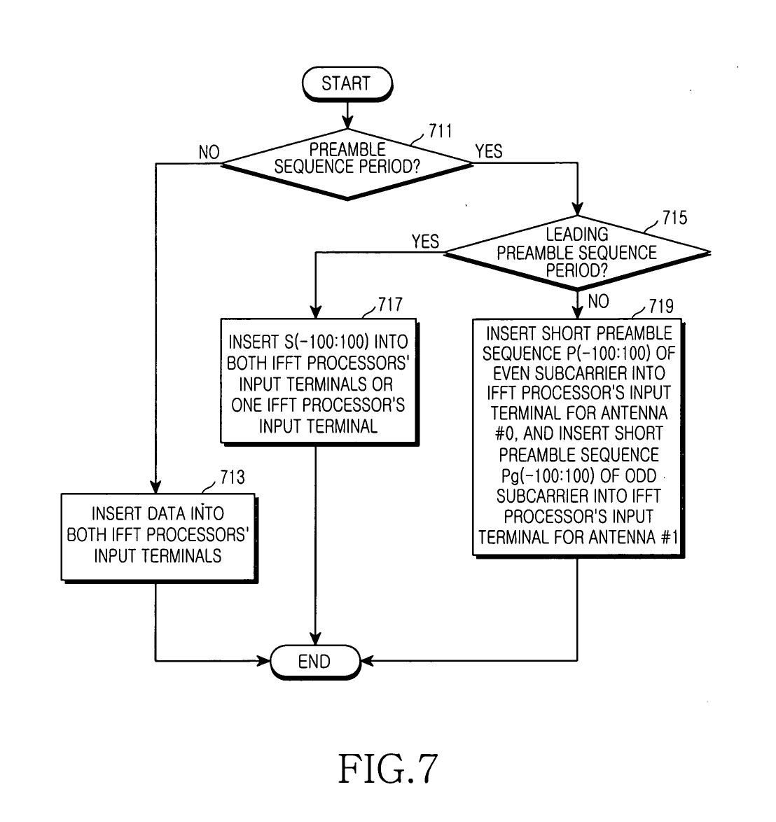

FIG. 7 illustrates Preamble Transmission Rule 2 for transmitting a preamble in an OFDM communication system using two transmission antennas according to an embodiment of the present invention. In step 711, a transmitter determines whether a transmission signal period is a preamble sequence period. The transmission signal is determined and selected by a selector as described above. If the transmission signal period is not a preamble sequence period, but a data transmission period, the transmitter proceeds to step 713. In step 713, the transmitter performs a control operation of mapping data to both IFFT processors' input terminals, and then ends the procedure.

However, if it is determined in step 711 that the transmission signal period is a preamble sequence period, the transmitter proceeds to step 715. In step 715, the transmitter determines whether the preamble sequence period is a leading preamble sequence period in a long preamble sequence period. If the preamble sequence period is a leading preamble sequence period in a long preamble sequence period, the transmitter proceeds to step 717, where the transmitter performs a control operation of mapping a leading preamble sequence S(−100:100) in the long preamble sequence period to corresponding subcarriers on the IFFT processor's input terminal, and then ends the procedure. The preamble sequence S(−100:100) is generated by a preamble sequence generator according to a control command from a controller, as described above.

If it is determined in step 715 that the preamble sequence period is not a leading preamble sequence period in a long preamble sequence period, but a short preamble sequence period (a following part period of the long preamble sequence period), then the transmitter proceeds to step 719. In step 719, the transmitter maps an even subcarrier's short preamble sequence P(−100:100) to an IFFT processor's input terminal for an antenna #0, maps an odd subcarrier's short preamble sequence Pg(−100:100) to an IFFT processor's input terminal for an antenna #1, and then ends the procedure. The “short preamble sequence of an even subcarrier” means a preamble sequence for which a unique number of a subcarrier into which data of +1 or −1, not null data, is inserted among elements constituting the short preamble sequence is an even number. Although the 0^{th} subcarrier (DC component) is an even subcarrier, it is excluded herein because null data should be necessarily inserted therein.

In addition, the “short preamble sequence of an odd subcarrier” means a preamble sequence for which a unique number of a subcarrier into which data of +1 or −1, not null data, is inserted among elements constituting the short preamble sequence is an odd number. In FIG. 7, an even subcarrier's short preamble sequence is transmitted via the antenna #0, and an odd subcarrier's short preamble sequence is transmitted via the antenna #1. Then a receiver performs accurate channel estimation by receiving the even subcarrier's short preamble sequence and the odd subcarrier's short preamble sequence.

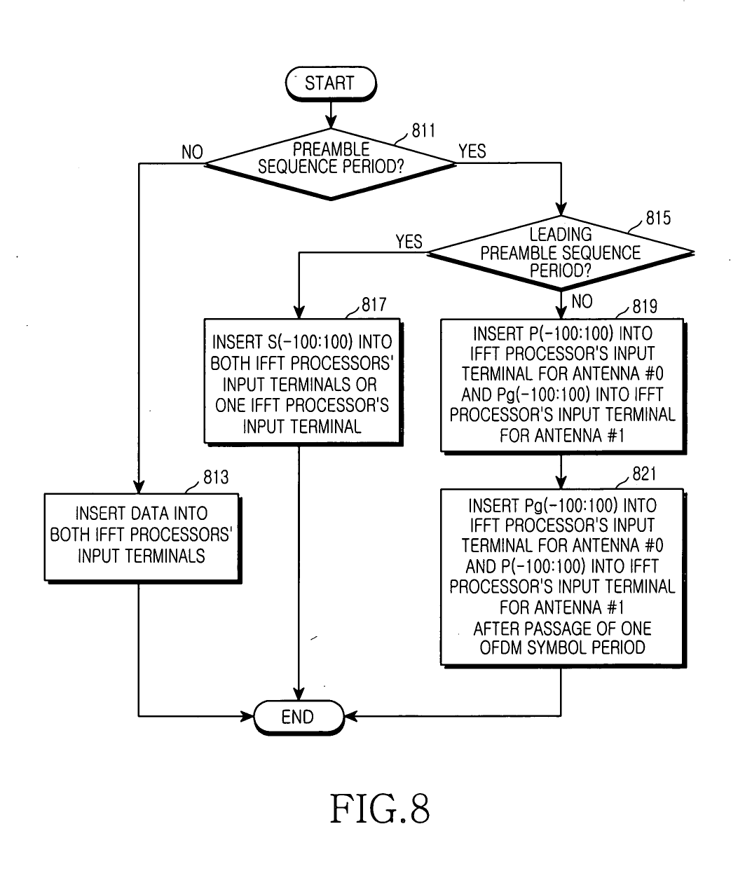

FIG. 8 illustrates Preamble Transmission Rule 3 for transmitting a preamble in an OFDM communication system using two transmission antennas according to an embodiment of the present invention. In step 811, a transmitter determines whether a transmission signal period is a preamble sequence period. The transmission signal is determined and selected by a selector as described above. If the transmission signal period is not a preamble sequence period, but a data transmission period, the transmitter proceeds to step 813. In step 813, the transmitter performs a control operation of mapping data to both IFFT processors' input terminals, and then ends the procedure.

If it is determined in step 811 that the transmission signal period is a preamble sequence period, the transmitter proceeds to step 815. In step 815, the transmitter determines whether the preamble sequence period is a leading preamble sequence period in a long preamble sequence period. If the preamble sequence period is a leading preamble sequence period in a long preamble sequence period, the transmitter proceeds to step 817.

In step 817, the transmitter performs a control operation of mapping a leading preamble sequence S(−100:100) in the long preamble sequence period to corresponding subcarriers on the IFFT processor's input terminal, and then ends the procedure. The preamble sequence S(−100:100) is generated by a preamble sequence generator according to a control command from a controller, as described above.

If it is determined in step 815 that the preamble sequence period is not a leading preamble sequence period in a long preamble sequence period, but a short preamble sequence period (a following part period of the long preamble sequence period), then the transmitter proceeds to step 819 where the transmitter maps an even subcarrier's short preamble sequence P(−100:100) to an IFFT processor's input terminal for an antenna #0, maps an odd subcarrier's short preamble sequence Pg(−100:100) to an IFFT processor's input terminal for an antenna #1, and then proceeds to step 821.

In step 821, the transmitter maps an odd subcarrier's short preamble sequence Pg(−100:100) to the IFFT processor's input terminal for the antenna #0, maps an even subcarrier's short preamble sequence P(−100:100) to the IFFT processor's input terminal for the antenna #1 after passage of one OFDM symbol period, and then ends the procedure.

In FIG. 8, the even subcarrier's short preamble sequence and the odd subcarrier's short preamble sequence are alternately transmitted via the antenna #0 and the antenna #1. Then a receiver performs accurate channel estimation by receiving the even subcarrier's short preamble sequence and the odd subcarrier's short preamble sequence.

As can be understood from the foregoing description, the present invention proposes an odd subcarrier's short preamble sequence having a low PAPR in an OFDM communication system, thereby improving a characteristic of a preamble sequence. In addition, the present invention transmits an odd subcarrier's short preamble sequence and an even subcarrier's short preamble sequence using one transmission antenna or two transmission antennas, so a receiver can perform correct channel estimation.

While the present invention has been shown and described with reference to a certain preferred embodiment thereof, it will be understood by those skilled in the art that various changes in form and details may be made therein without departing from the spirit and scope of the present invention as defined by the appended claims.

What is claimed is:

1. A method for generating a preamble sequence to decrease a peak-to-average power ratio (PAPR) through at least two antennas in an orthogonal frequency division multiplexing (OFDM) communication system including an inverse fast Fourier transform (IFFT) processor for IFFT-transforming an input preamble sequence for a plurality of subcarriers in a frequency domain and generating a preamble sequence corresponding to the subcarriers in a time domain, the method comprising the steps of:
generating a first preamble sequence in which odd data of the preamble sequence becomes null data and even data of the preamble sequence becomes data, the first preamble sequence being adapted to be transmitted via one of the at least two antennas; and
generating a second preamble sequence in which the even data of the preamble sequence becomes null data and the odd data of the preamble sequence becomes data, the second preamble sequence being adapted to be transmitted via another one of the at least two antennas.

2. The method of claim 1, wherein the second preamble sequence is defined as Pg(−100:100), where:
$$\begin{matrix}Pg ( - 100 \text{:} 100 ) = \{ 0 , - 1 , 0 , - 1 , 0 , + 1 , 0 , - 1 , 0 , + 1 , 0 , - 1 , 0 , + 1 , 0 , + 1 , 0 , - 1 , 0 , - 1 , \\ 0 , + 1 , 0 , + 1 , 0 , - 1 , 0 , + 1 , 0 , - 1 , 0 , + 1 , 0 , - 1 , 0 , - 1 , 0 , + 1 , 0 , + 1 , \\ 0 , + 1 , 0 , + 1 , 0 , - 1 , 0 , + 1 , 0 , - 1 , 0 , + 1 , 0 , - 1 , 0 , - 1 , 0 , + 1 , 0 , + 1 , \\ 0 , - 1 , 0 , - 1 , 0 , + 1 , 0 , - 1 , 0 , + 1 , 0 , - 1 , 0 , + 1 , 0 , + 1 , 0 , - 1 , 0 , - 1 , \\ 0 , - 1 , 0 , - 1 , 0 , + 1 , 0 , + 1 , 0 , + 1 , 0 , + 1 , 0 , + 1 , 0 , - 1 , 0 , + 1 , 0 , + 1 , \\ , - 1 , \\ 0 , - 1 , 0 , + 1 , 0 , - 1 , 0 , + 1 , 0 , - 1 , 0 , + 1 , 0 , + 1 , 0 , - 1 , 0 , - 1 , 0 , - 1 , \\ 0 , - 1 , 0 , + 1 , 0 , + 1 , 0 , + 1 , 0 , + 1 , 0 , + 1 , 0 , - 1 , 0 , + 1 , 0 , + 1 , 0 , - 1 , \\ 0 , - 1 , 0 , + 1 , 0 , + 1 , 0 , + 1 , 0 , + 1 , 0 , + 1 , 0 , - 1 , 0 , + 1 , 0 , + 1 , 0 , - 1 , \\ 0 , - 1 , 0 , + 1 , 0 , + 1 , 0 , + 1 , 0 , + 1 , 0 , + 1 , 0 , - 1 , 0 , + 1 , 0 , + 1 , 0 , + 1 , \\ 0 , + 1 , 0 , - 1 , 0 , - 1 , 0 , - 1 , 0 , - 1 , 0 , - 1 , 0 , + 1 , 0 , - 1 , 0 , - 1 , 0 \} * \\ sqrt ( 2 ) * sqrt ( 2 )\end{matrix}$$

3. The method of claim 1, wherein the first preamble sequence P(−100:100) is defined as P(−100:100), where:
$$\begin{matrix}P ( - 100 \text{:} 100 ) = \{ - 1 , 0 , + 1 , 0 + 1 , 0 , + 1 , 0 , + 1 , 0 , - 1 , 0 , - 1 , 0 , + 1 , 0 , - 1 , 0 , + 1 , 0 , \\ - 1 , 0 , - 1 , 0 + 1 , 0 , + 1 , 0 , - 1 , 0 , + 1 , 0 , - 1 , 0 , + 1 , 0 , - 1 , 0 , + 1 , 0 , \\ - 1 , 0 , + 1 , 0 + 1 , 0 , - 1 , 0 , + 1 , 0 , - 1 , 0 , - 1 , 0 , + 1 , 0 , - 1 , 0 , - 1 , 0 , \\ - 1 , 0 , + 1 , 0 + 1 , 0 , - 1 , 0 , + 1 , 0 , + 1 , 0 , + 1 , 0 , - 1 , 0 , + 1 , 0 , + 1 , 0 , \\ - 1 , 0 , - 1 , 0 - 1 , 0 , + 1 , 0 , + 1 , 0 , + 1 , 0 , + 1 , 0 , + 1 , 0 , + 1 , 0 , + 1 , 0 , \\ 0 , 0 , \\ - 1 , 0 , - 1 , 0 + 1 , 0 , - 1 , 0 , - 1 , 0 , + 1 , 0 , + 1 , 0 , + 1 , 0 , - 1 , 0 , + 1 , 0 , \\ + 1 , 0 , + 1 , 0 - 1 , 0 , - 1 , 0 , - 1 , 0 , - 1 , 0 , - 1 , 0 , - 1 , 0 , + 1 , 0 , - 1 , 0 , \\ - 1 , 0 , - 1 , 0 - 1 , 0 , - 1 , 0 , - 1 , 0 , + 1 , 0 , + 1 , 0 , + 1 , 0 , - 1 , 0 , + 1 , 0 , \\ - 1 , 0 , + 1 , 0 + 1 , 0 , - 1 , 0 , + 1 , 0 , + 1 , 0 , + 1 , 0 , - 1 , 0 , - 1 , 0 , - 1 , 0 , \\ - 1 , 0 , - 1 , 0 + 1 , 0 , - 1 , 0 , - 1 , 0 , + 1 , 0 , - 1 , 0 , - 1 , 0 , + 1 , 0 , - 1 \} * \\ sqrt ( 2 ) * sqrt ( 2 )\end{matrix}$$

4. A method for generating a preamble sequence to decrease a peak-to-average power ratio (PAPR) in an orthogonal frequency division multiplexing (OFDM) communication system including an inverse fast Fourier transform (IFFT) processor for IFFT-transforming an input preamble sequence for a plurality of subcarriers in a frequency domain and generating a preamble sequence corresponding to the subcarriers in a time domain, the method comprising the steps of:
generating a first preamble sequence in which odd data of the preamble sequence becomes null data and even data of the preamble sequence becomes data, for one OFDM symbol period; and
generating a second preamble sequence in which the even data of the preamble sequence becomes null data and the odd data of the preamble sequence becomes data, for a next OFDM symbol period after passage of the one OFDM symbol period.

5. The method of claim 4, wherein the second preamble sequence is defined as Pg(−100:100), where:
$$\begin{matrix}Pg ( - 100 \text{:} 100 ) = \{ 0 , - 1 , 0 , - 1 , 0 , + 1 , 0 , - 1 , 0 , + 1 , 0 , - 1 , 0 , + 1 , 0 , + 1 , 0 , - 1 , 0 , - 1 , \\ 0 , + 1 , 0 , + 1 , 0 , - 1 , 0 , + 1 , 0 , - 1 , 0 , + 1 , 0 , - 1 , 0 , - 1 , 0 , + 1 , 0 , + 1 , \\ 0 , + 1 , 0 , + 1 , 0 , - 1 , 0 , + 1 , 0 , - 1 , 0 , + 1 , 0 , - 1 , 0 , - 1 , 0 , + 1 , 0 , + 1 , \\ 0 , - 1 , 0 , - 1 , 0 , + 1 , 0 , - 1 , 0 , + 1 , 0 , - 1 , 0 , + 1 , 0 , + 1 , 0 , - 1 , 0 , - 1 , \\ 0 , - 1 , 0 , - 1 , 0 , + 1 , 0 , + 1 , 0 , + 1 , 0 , + 1 , 0 , + 1 , 0 , - 1 , 0 , + 1 , 0 , + 1 , \\ , - 1 , \\ 0 , - 1 , 0 , + 1 , 0 , - 1 , 0 , + 1 , 0 , - 1 , 0 , + 1 , 0 , + 1 , 0 , - 1 , 0 , - 1 , 0 , - 1 , \\ 0 , - 1 , 0 , + 1 , 0 , + 1 , 0 , + 1 , 0 , + 1 , 0 , + 1 , 0 , - 1 , 0 , + 1 , 0 , + 1 , 0 , - 1 , \\ 0 , - 1 , 0 , + 1 , 0 , + 1 , 0 , + 1 , 0 , + 1 , 0 , + 1 , 0 , - 1 , 0 , + 1 , 0 , + 1 , 0 , - 1 , \\ 0 , - 1 , 0 , + 1 , 0 , + 1 , 0 , + 1 , 0 , + 1 , 0 , + 1 , 0 , - 1 , 0 , + 1 , 0 , + 1 , 0 , + 1 , \\ 0 , + 1 , 0 , - 1 , 0 , - 1 , 0 , - 1 , 0 , - 1 , 0 , - 1 , 0 , + 1 , 0 , - 1 , 0 , - 1 , 0 \} * \\ sqrt ( 2 ) * sqrt ( 2 )\end{matrix}$$

6. The method of claim 4, wherein the first preamble sequence is defined as P(−100:100), where:
$$\begin{matrix}P ( - 100 \text{:} 100 ) = \{ - 1 , 0 , + 1 , 0 + 1 , 0 , + 1 , 0 , + 1 , 0 , - 1 , 0 , - 1 , 0 , + 1 , 0 , - 1 , 0 , + 1 , 0 , \\ - 1 , 0 , - 1 , 0 + 1 , 0 , + 1 , 0 , - 1 , 0 , + 1 , 0 , - 1 , 0 , + 1 , 0 , - 1 , 0 , + 1 , 0 , \\ - 1 , 0 , + 1 , 0 + 1 , 0 , - 1 , 0 , + 1 , 0 , - 1 , 0 , - 1 , 0 , + 1 , 0 , - 1 , 0 , - 1 , 0 , \\ - 1 , 0 , + 1 , 0 + 1 , 0 , - 1 , 0 , + 1 , 0 , + 1 , 0 , + 1 , 0 , - 1 , 0 , + 1 , 0 , + 1 , 0 , \\ - 1 , 0 , - 1 , 0 - 1 , 0 , + 1 , 0 , + 1 , 0 , + 1 , 0 , + 1 , 0 , + 1 , 0 , + 1 , 0 , + 1 , 0 , \\ 0 , 0 , \\ - 1 , 0 , - 1 , 0 + 1 , 0 , - 1 , 0 , - 1 , 0 , + 1 , 0 , + 1 , 0 , + 1 , 0 , - 1 , 0 , + 1 , 0 , \\ + 1 , 0 , + 1 , 0 - 1 , 0 , - 1 , 0 , - 1 , 0 , - 1 , 0 , - 1 , 0 , - 1 , 0 , + 1 , 0 , - 1 , 0 , \\ - 1 , 0 , - 1 , 0 - 1 , 0 , - 1 , 0 , - 1 , 0 , + 1 , 0 , + 1 , 0 , + 1 , 0 , - 1 , 0 , + 1 , 0 , \\ - 1 , 0 , + 1 , 0 + 1 , 0 , - 1 , 0 , + 1 , 0 , + 1 , 0 , + 1 , 0 , - 1 , 0 , - 1 , 0 , - 1 , 0 , \\ - 1 , 0 , - 1 , 0 + 1 , 0 , - 1 , 0 , - 1 , 0 , + 1 , 0 , - 1 , 0 , - 1 , 0 , + 1 , 0 , - 1 \} * \\ sqrt ( 2 ) * sqrt ( 2 )\end{matrix}$$

7. A method for generating a preamble sequence to decrease a peak-to-average power ratio (PAPR) through two antennas in an orthogonal frequency division multiplexing (OFDM) communication system including an inverse fast Fourier transform (IFFT) processor for IFFT-transforming an input preamble sequence for a plurality of subcarriers in a frequency domain and generating a preamble sequence corresponding to the subcarriers in a time domain, the method comprising the steps of:
generating a first preamble sequence in which odd data of the preamble sequence becomes null data and even data of the preamble sequence becomes data, the first preamble sequence being adapted to be transmitted via the first of the two antennas for one OFDM symbol period, and generating a second preamble sequence in which the even data of the preamble sequence becomes null data and the odd data of the preamble sequence becomes data, the second preamble sequence being adapted to be transmitted via the second of the two antennas for the one OFDM symbol period; and
generating the first preamble sequence in which odd data of the preamble sequence becomes null data and even data of the preamble sequence becomes data, the first preamble sequence being adapted to be transmitted via the second of the two antennas for a next OFDM symbol period after passage of the one OFDM symbol period, and generating the second preamble sequence in which the even data of the preamble sequence becomes null data and the odd data of the preamble sequence becomes data, the second preamble sequence being adapted to be transmitted via the first of the two antennas for the next OFDM symbol period.

8. The method of claim 7, wherein the second preamble sequence is defined as Pg(−100:100), where:
$$\begin{matrix}Pg ( - 100 \text{:} 100 ) = \{ 0 , - 1 , 0 , - 1 , 0 , + 1 , 0 , - 1 , 0 , + 1 , 0 , - 1 , 0 , + 1 , 0 , + 1 , 0 , - 1 , 0 , - 1 , \\ 0 , + 1 , 0 , + 1 , 0 , - 1 , 0 , + 1 , 0 , - 1 , 0 , + 1 , 0 , - 1 , 0 , - 1 , 0 , + 1 , 0 , + 1 , \\ 0 , + 1 , 0 , + 1 , 0 , - 1 , 0 , + 1 , 0 , - 1 , 0 , + 1 , 0 , - 1 , 0 , - 1 , 0 , + 1 , 0 , + 1 , \\ 0 , - 1 , 0 , - 1 , 0 , + 1 , 0 , - 1 , 0 , + 1 , 0 , - 1 , 0 , + 1 , 0 , + 1 , 0 , - 1 , 0 , - 1 , \\ 0 , - 1 , 0 , - 1 , 0 , + 1 , 0 , + 1 , 0 , + 1 , 0 , + 1 , 0 , + 1 , 0 , - 1 , 0 , + 1 , 0 , + 1 , \\ , - 1 , \\ 0 , - 1 , 0 , + 1 , 0 , - 1 , 0 , + 1 , 0 , - 1 , 0 , + 1 , 0 , + 1 , 0 , - 1 , 0 , - 1 , 0 , - 1 , \\ 0 , - 1 , 0 , + 1 , 0 , + 1 , 0 , + 1 , 0 , + 1 , 0 , + 1 , 0 , - 1 , 0 , + 1 , 0 , + 1 , 0 , - 1 , \\ 0 , - 1 , 0 , + 1 , 0 , + 1 , 0 , + 1 , 0 , + 1 , 0 , + 1 , 0 , - 1 , 0 , + 1 , 0 , + 1 , 0 , - 1 , \\ 0 , - 1 , 0 , + 1 , 0 , + 1 , 0 , + 1 , 0 , + 1 , 0 , + 1 , 0 , - 1 , 0 , + 1 , 0 , + 1 , 0 , + 1 , \\ 0 , + 1 , 0 , - 1 , 0 , - 1 , 0 , - 1 , 0 , - 1 , 0 , - 1 , 0 , + 1 , 0 , - 1 , 0 , - 1 , 0 \} * \\ sqrt ( 2 ) * sqrt ( 2 )\end{matrix}$$

9. The method of claim 7, wherein the first preamble sequence is defined as P(−100:100), where:
$$\begin{matrix}P ( - 100 \text{:} 100 ) = \{ - 1 , 0 , + 1 , 0 + 1 , 0 , + 1 , 0 , + 1 , 0 , - 1 , 0 , - 1 , 0 , + 1 , 0 , - 1 , 0 , + 1 , 0 , \\ - 1 , 0 , - 1 , 0 + 1 , 0 , + 1 , 0 , - 1 , 0 , + 1 , 0 , - 1 , 0 , + 1 , 0 , - 1 , 0 , + 1 , 0 , \\ - 1 , 0 , + 1 , 0 + 1 , 0 , - 1 , 0 , + 1 , 0 , - 1 , 0 , - 1 , 0 , + 1 , 0 , - 1 , 0 , - 1 , 0 , \\ - 1 , 0 , + 1 , 0 + 1 , 0 , - 1 , 0 , + 1 , 0 , + 1 , 0 , + 1 , 0 , - 1 , 0 , + 1 , 0 , + 1 , 0 , \\ - 1 , 0 , - 1 , 0 - 1 , 0 , + 1 , 0 , + 1 , 0 , + 1 , 0 , + 1 , 0 , + 1 , 0 , + 1 , 0 , + 1 , 0 , \\ 0 , 0 , \\ - 1 , 0 , - 1 , 0 + 1 , 0 , - 1 , 0 , - 1 , 0 , + 1 , 0 , + 1 , 0 , + 1 , 0 , - 1 , 0 , + 1 , 0 , \\ + 1 , 0 , + 1 , 0 - 1 , 0 , - 1 , 0 , - 1 , 0 , - 1 , 0 , - 1 , 0 , - 1 , 0 , + 1 , 0 , - 1 , 0 , \\ - 1 , 0 , - 1 , 0 - 1 , 0 , - 1 , 0 , - 1 , 0 , + 1 , 0 , + 1 , 0 , + 1 , 0 , - 1 , 0 , + 1 , 0 , \\ - 1 , 0 , + 1 , 0 + 1 , 0 , - 1 , 0 , + 1 , 0 , + 1 , 0 , + 1 , 0 , - 1 , 0 , - 1 , 0 , - 1 , 0 , \\ - 1 , 0 , - 1 , 0 + 1 , 0 , - 1 , 0 , - 1 , 0 , + 1 , 0 , - 1 , 0 , - 1 , 0 , + 1 , 0 , - 1 \} * \\ sqrt ( 2 ) * sqrt ( 2 )\end{matrix}$$

10. An apparatus for generating a preamble sequence to decrease a peak-to-average power ratio (PAPR) through at least two antennas in an orthogonal frequency division multiplexing (OFDM) communication system including an inverse fast Fourier transform (IFFT) processor for IFFT-transforming an input preamble sequence for a plurality of subcarriers in a frequency domain and generating a preamble sequence corresponding to the subcarriers in a time domain, the apparatus comprising:
a first antenna preamble sequence generator for generating a first preamble sequence in which odd data of the preamble sequence becomes null data and even data of the preamble sequence becomes data, the first preamble sequence being adapted to be transmitted via one of the at least two antennas; and
a second antenna preamble sequence generator for generating a second preamble sequence in which the even data of the preamble sequence becomes null data and the odd data of the preamble sequence becomes data, the second preamble sequence being adapted to be transmitted via another one of the at least two antennas.

11. The apparatus of claim 10, wherein the second preamble sequence is defined as Pg(−100:100), where:
$$\begin{matrix}Pg ( - 100 \text{:} 100 ) = \{ 0 , - 1 , 0 , - 1 , 0 , + 1 , 0 , - 1 , 0 , + 1 , 0 , - 1 , 0 , + 1 , 0 , + 1 , 0 , - 1 , 0 , - 1 , \\ 0 , + 1 , 0 , + 1 , 0 , - 1 , 0 , + 1 , 0 , - 1 , 0 , + 1 , 0 , - 1 , 0 , - 1 , 0 , + 1 , 0 , + 1 , \\ 0 , + 1 , 0 , + 1 , 0 , - 1 , 0 , + 1 , 0 , - 1 , 0 , + 1 , 0 , - 1 , 0 , - 1 , 0 , + 1 , 0 , + 1 , \\ 0 , - 1 , 0 , - 1 , 0 , + 1 , 0 , - 1 , 0 , + 1 , 0 , - 1 , 0 , + 1 , 0 , + 1 , 0 , - 1 , 0 , - 1 , \\ 0 , - 1 , 0 , - 1 , 0 , + 1 , 0 , + 1 , 0 , + 1 , 0 , + 1 , 0 , + 1 , 0 , - 1 , 0 , + 1 , 0 , + 1 , \\ , - 1 , \\ 0 , - 1 , 0 , + 1 , 0 , - 1 , 0 , + 1 , 0 , - 1 , 0 , + 1 , 0 , + 1 , 0 , - 1 , 0 , - 1 , 0 , - 1 , \\ 0 , - 1 , 0 , + 1 , 0 , + 1 , 0 , + 1 , 0 , + 1 , 0 , + 1 , 0 , - 1 , 0 , + 1 , 0 , + 1 , 0 , - 1 , \\ 0 , - 1 , 0 , + 1 , 0 , + 1 , 0 , + 1 , 0 , + 1 , 0 , + 1 , 0 , - 1 , 0 , + 1 , 0 , + 1 , 0 , - 1 , \\ 0 , - 1 , 0 , + 1 , 0 , + 1 , 0 , + 1 , 0 , + 1 , 0 , + 1 , 0 , - 1 , 0 , + 1 , 0 , + 1 , 0 , + 1 , \\ 0 , + 1 , 0 , - 1 , 0 , - 1 , 0 , - 1 , 0 , - 1 , 0 , - 1 , 0 , + 1 , 0 , - 1 , 0 , - 1 , 0 \} * \\ sqrt ( 2 ) * sqrt ( 2 )\end{matrix}$$

12. The apparatus of claim 10, wherein the first preamble sequence is defined as P(−100:100), where:
$$\begin{matrix}P ( - 100 \text{:} 100 ) = \{ - 1 , 0 , + 1 , 0 + 1 , 0 , + 1 , 0 , + 1 , 0 , - 1 , 0 , - 1 , 0 , + 1 , 0 , - 1 , 0 , + 1 , 0 , \\ - 1 , 0 , - 1 , 0 + 1 , 0 , + 1 , 0 , - 1 , 0 , + 1 , 0 , - 1 , 0 , + 1 , 0 , - 1 , 0 , + 1 , 0 , \\ - 1 , 0 , + 1 , 0 + 1 , 0 , - 1 , 0 , + 1 , 0 , - 1 , 0 , - 1 , 0 , + 1 , 0 , - 1 , 0 , - 1 , 0 , \\ - 1 , 0 , + 1 , 0 + 1 , 0 , - 1 , 0 , + 1 , 0 , + 1 , 0 , + 1 , 0 , - 1 , 0 , + 1 , 0 , + 1 , 0 , \\ - 1 , 0 , - 1 , 0 - 1 , 0 , + 1 , 0 , + 1 , 0 , + 1 , 0 , + 1 , 0 , + 1 , 0 , + 1 , 0 , + 1 , 0 , \\ 0 , 0 , \\ - 1 , 0 , - 1 , 0 + 1 , 0 , - 1 , 0 , - 1 , 0 , + 1 , 0 , + 1 , 0 , + 1 , 0 , - 1 , 0 , + 1 , 0 , \\ + 1 , 0 , + 1 , 0 - 1 , 0 , - 1 , 0 , - 1 , 0 , - 1 , 0 , - 1 , 0 , - 1 , 0 , + 1 , 0 , - 1 , 0 , \\ - 1 , 0 , - 1 , 0 - 1 , 0 , - 1 , 0 , - 1 , 0 , + 1 , 0 , + 1 , 0 , + 1 , 0 , - 1 , 0 , + 1 , 0 , \\ - 1 , 0 , + 1 , 0 + 1 , 0 , - 1 , 0 , + 1 , 0 , + 1 , 0 , + 1 , 0 , - 1 , 0 , - 1 , 0 , - 1 , 0 , \\ - 1 , 0 , - 1 , 0 + 1 , 0 , - 1 , 0 , - 1 , 0 , + 1 , 0 , - 1 , 0 , - 1 , 0 , + 1 , 0 , - 1 \} * \\ sqrt ( 2 ) * sqrt ( 2 )\end{matrix}$$

13. An apparatus for generating a preamble sequence to decrease a peak-to-average power ratio (PAPR) in an orthogonal frequency division multiplexing (OFDM) communication system including an inverse fast Fourier transform (IFFT) processor for IFFT-transforming an input preamble sequence for a plurality of subcarriers in a frequency domain and generating a preamble sequence corresponding to the subcarriers in a time domain, the apparatus comprising:
a preamble sequence generator for generating a first preamble sequence in which odd data of the preamble sequence becomes null data and even data of the preamble sequence becomes data, for one OFDM symbol period, and generating a second preamble sequence in which the even data of the preamble sequence becomes null data and the odd data of the preamble sequence becomes data, for a next OFDM symbol period after passage of the one OFDM symbol period.

14. The apparatus of claim 13, wherein the second preamble sequence is defined as Pg(−100:100), where:
$$Pg ( - 100 \text{:} 100 ) = \begin{matrix}\{ & 0 , - 1 , 0 , - 1 , 0 , + 1 , 0 , - 1 , 0 , + 1 , 0 , - 1 , 0 , + 1 , 0 , + 1 , 0 , - 1 , 0 , - 1 , \\ & 0 , + 1 , 0 , + 1 , 0 , - 1 , 0 , + 1 , 0 , - 1 , 0 , + 1 , 0 , - 1 , 0 , - 1 , 0 , + 1 , 0 , + 1 , \\ & 0 , + 1 , 0 , + 1 , 0 , - 1 , 0 , + 1 , 0 , - 1 , 0 , + 1 , 0 , - 1 , 0 , - 1 , 0 , + 1 , 0 , + 1 , \\ & 0 , - 1 , 0 , - 1 , 0 , + 1 , 0 , - 1 , 0 , + 1 , 0 , - 1 , 0 , + 1 , 0 , + 1 , 0 , - 1 , 0 , - 1 , \\ & 0 , - 1 , 0 , - 1 , 0 , + 1 , 0 , + 1 , 0 , + 1 , 0 , + 1 , 0 , + 1 , 0 , - 1 , 0 , + 1 , 0 , + 1 , \\ & 0 , - 1 , \\ & 0 , - 1 , 0 , + 1 , 0 , - 1 , 0 , + 1 , 0 , - 1 , 0 , + 1 , 0 , + 1 , 0 , - 1 , 0 , - 1 , 0 , - 1 , \\ & 0 , - 1 , 0 , + 1 , 0 , + 1 , 0 , + 1 , 0 , + 1 , 0 , + 1 , 0 , - 1 , 0 , + 1 , 0 , + 1 , 0 , - 1 , \\ & 0 , - 1 , 0 , + 1 , 0 , + 1 , 0 , + 1 , 0 , + 1 , 0 , + 1 , 0 , - 1 , 0 , + 1 , 0 , + 1 , 0 , - 1 , \\ & 0 , - 1 , 0 , + 1 , 0 , + 1 , 0 , + 1 , 0 , + 1 , 0 , + 1 , 0 , - 1 , 0 , + 1 , 0 , + 1 , 0 , + 1 , \\ & 0 , + 1 , 0 , - 1 , 0 , - 1 , 0 , - 1 , 0 , - 1 , 0 , - 1 , 0 , + 1 , 0 , - 1 , 0 , - 1 , 0 \} \\ & * sqrt ( 2 ) * sqrt ( 2 )\end{matrix}$$

15. The apparatus of claim 13, wherein the first preamble sequence is defined as P(−100:100), where:
$$P ( - 100 \text{:} 100 ) = \begin{matrix}\{ & - 1 , 0 , + 1 , 0 , + 1 , 0 , + 1 , 0 , + 1 , 0 , - 1 , 0 , - 1 , 0 , + 1 , 0 , - 1 , 0 , + 1 , 0 , \\ & - 1 , 0 , - 1 , 0 , + 1 , 0 , + 1 , 0 , - 1 , 0 , + 1 , 0 , - 1 , 0 , + 1 , 0 , - 1 , 0 , + 1 , 0 , \\ & - 1 , 0 , + 1 , 0 , + 1 , 0 , - 1 , 0 , + 1 , 0 , - 1 , 0 , - 1 , 0 , + 1 , 0 , - 1 , 0 , - 1 , 0 , \\ & - 1 , 0 , + 1 , 0 , + 1 , 0 , - 1 , 0 , + 1 , 0 , + 1 , 0 , + 1 , 0 , - 1 , 0 , + 1 , 0 , + 1 , 0 , \\ & - 1 , 0 , - 1 , 0 , - 1 , 0 , + 1 , 0 , + 1 , 0 , + 1 , 0 , + 1 , 0 , + 1 , 0 , + 1 , 0 , + 1 , 0 , \\ & 0 , 0 , \\ & - 1 , 0 , - 1 , 0 , + 1 , 0 , - 1 , 0 , - 1 , 0 , + 1 , 0 , + 1 , 0 , + 1 , 0 , - 1 , 0 , + 1 , 0 , \\ & + 1 , 0 , + 1 , 0 , - 1 , 0 , - 1 , 0 , - 1 , 0 , - 1 , 0 , - 1 , 0 , - 1 , 0 , + 1 , 0 , - 1 , 0 , \\ & - 1 , 0 , - 1 , 0 , - 1 , 0 , - 1 , 0 , - 1 , 0 , + 1 , 0 , + 1 , 0 , + 1 , 0 , - 1 , 0 , + 1 , 0 , \\ & - 1 , 0 , + 1 , 0 , + 1 , 0 , - 1 , 0 , + 1 , 0 , + 1 , 0 , + 1 , 0 , - 1 , 0 , - 1 , 0 , - 1 , 0 , \\ & - 1 , 0 , - 1 , 0 , + 1 , 0 , - 1 , 0 , - 1 , 0 , + 1 , 0 , - 1 , 0 , - 1 , 0 , + 1 , 0 , - 1 \} \\ & * sqrt ( 2 ) * sqrt ( 2 )\end{matrix}$$

16. An apparatus for generating a preamble sequence to decrease a peak-to-average power ratio (PAPR) through at least two antennas in an orthogonal frequency division multiplexing (OFDM) communication system including an inverse fast Fourier transform (IFFT) processor for IFFT-transforming an input preamble sequence for a plurality of subcarriers in a frequency domain and generating a preamble sequence corresponding to the subcarriers in a time domain, the apparatus comprising:
a first antenna preamble sequence generator for generating a first preamble sequence in which odd data of the preamble sequence becomes null data and even data of the preamble sequence becomes data, the first preamble sequence being adapted to be transmitted via the first of the two antennas for one OFDM symbol period, and the second of the two antennas for a next OFDM symbol period after passage of the one OFDM symbol period; and
a second antenna preamble sequence generator for generating a second preamble sequence in which the even data of the preamble sequence becomes null data and the odd data of the preamble sequence becomes data, the second preamble sequence being adapted to be transmitted via the second of the two antennas for one OFDM symbol period and the first of the two antennas for the next OFDM symbol period.

17. The apparatus of claim 16, wherein the second preamble sequence is defined as Pg(−100:100), where:
$$Pg ( - 100 \text{:} 100 ) = \begin{matrix}\{ & 0 , - 1 , 0 , - 1 , 0 , + 1 , 0 , - 1 , 0 , + 1 , 0 , - 1 , 0 , + 1 , 0 , + 1 , 0 , - 1 , 0 , - 1 , \\ & 0 , + 1 , 0 , + 1 , 0 , - 1 , 0 , + 1 , 0 , - 1 , 0 , + 1 , 0 , - 1 , 0 , - 1 , 0 , + 1 , 0 , + 1 , \\ & 0 , + 1 , 0 , + 1 , 0 , - 1 , 0 , + 1 , 0 , - 1 , 0 , + 1 , 0 , - 1 , 0 , - 1 , 0 , + 1 , 0 , + 1 , \\ & 0 , - 1 , 0 , - 1 , 0 , + 1 , 0 , - 1 , 0 , + 1 , 0 , - 1 , 0 , + 1 , 0 , + 1 , 0 , - 1 , 0 , - 1 , \\ & 0 , - 1 , 0 , - 1 , 0 , + 1 , 0 , + 1 , 0 , + 1 , 0 , + 1 , 0 , + 1 , 0 , - 1 , 0 , + 1 , 0 , + 1 , \\ & , - 1 , \\ & 0 , - 1 , 0 , + 1 , 0 , - 1 , 0 , + 1 , 0 , - 1 , 0 , + 1 , 0 , + 1 , 0 , - 1 , 0 , - 1 , 0 , - 1 , \\ & 0 , - 1 , 0 , + 1 , 0 , + 1 , 0 , + 1 , 0 , + 1 , 0 , + 1 , 0 , - 1 , 0 , + 1 , 0 , + 1 , 0 , - 1 , \\ & 0 , - 1 , 0 , + 1 , 0 , + 1 , 0 , + 1 , 0 , + 1 , 0 , + 1 , 0 , - 1 , 0 , + 1 , 0 , + 1 , 0 , - 1 , \\ & 0 , - 1 , 0 , + 1 , 0 , + 1 , 0 , + 1 , 0 , + 1 , 0 , + 1 , 0 , - 1 , 0 , + 1 , 0 , + 1 , 0 , + 1 , \\ & 0 , + 1 , 0 , - 1 , 0 , - 1 , 0 , - 1 , 0 , - 1 , 0 , - 1 , 0 , + 1 , 0 , - 1 , 0 , - 1 , 0 \} \\ & * sqrt ( 2 ) * sqrt ( 2 )\end{matrix}$$

18. The apparatus of claim 16, wherein the first preamble sequence is defined as P(−100:100), where:
$$P ( - 100 \text{:} 100 ) = \begin{matrix}\{ & - 1 , 0 , + 1 , 0 , + 1 , 0 , + 1 , 0 , + 1 , 0 , - 1 , 0 , - 1 , 0 , + 1 , 0 , - 1 , 0 , + 1 , 0 , \\ & - 1 , 0 , - 1 , 0 , + 1 , 0 , + 1 , 0 , - 1 , 0 , + 1 , 0 , - 1 , 0 , + 1 , 0 , - 1 , 0 , + 1 , 0 , \\ & - 1 , 0 , + 1 , 0 , + 1 , 0 , - 1 , 0 , + 1 , 0 , - 1 , 0 , - 1 , 0 , + 1 , 0 , - 1 , 0 , - 1 , 0 , \\ & - 1 , 0 , + 1 , 0 , + 1 , 0 , - 1 , 0 , + 1 , 0 , + 1 , 0 , + 1 , 0 , - 1 , 0 , + 1 , 0 , + 1 , 0 , \\ & - 1 , 0 , - 1 , 0 , - 1 , 0 , + 1 , 0 , + 1 , 0 , + 1 , 0 , + 1 , 0 , + 1 , 0 , + 1 , 0 , + 1 , 0 , \\ & 0 , 0 , \\ & - 1 , 0 , - 1 , 0 , + 1 , 0 , - 1 , 0 , - 1 , 0 , + 1 , 0 , + 1 , 0 , + 1 , 0 , - 1 , 0 , + 1 , 0 , \\ & + 1 , 0 , + 1 , 0 , - 1 , 0 , - 1 , 0 , - 1 , 0 , - 1 , 0 , - 1 , 0 , - 1 , 0 , + 1 , 0 , - 1 , 0 , \\ & - 1 , 0 , - 1 , 0 , - 1 , 0 , - 1 , 0 , - 1 , 0 , + 1 , 0 , + 1 , 0 , + 1 , 0 , - 1 , 0 , + 1 , 0 , \\ & - 1 , 0 , + 1 , 0 , + 1 , 0 , - 1 , 0 , + 1 , 0 , + 1 , 0 , + 1 , 0 , - 1 , 0 , - 1 , 0 , - 1 , 0 , \\ & - 1 , 0 , - 1 , 0 , + 1 , 0 , - 1 , 0 , - 1 , 0 , + 1 , 0 , - 1 , 0 , - 1 , 0 , + 1 , 0 , - 1 \} \\ & * sqrt ( 2 ) * sqrt ( 2 )\end{matrix}$$
